(19) United States
(12) Patent Application Publication
(10) Pub. No.: US 2015/0227877 A1
(43) Pub. Date: Aug. 13, 2015

(54) Processing Jobs in a Laboratory Management System

(71) Applicant: Essilor International (Compagnie Generale d'Optique) S.A., Charenton-le-Pont (FR)

(72) Inventors: Abbas Kafi, Plano, TX (US); Steve Morris, Flower Mound, TX (US); Jason Maxfield, Happy Valley, OR (US)

(73) Assignee: Essilor International (Compagnie Generale d'Optique) S.A., Charenton-le-Pont (FR)

(21) Appl. No.: 14/179,761

(22) Filed: Feb. 13, 2014

(51) Int. Cl. G06Q 10/06

(52) U.S. Cl. CPC G06Q 10/06316

(57) ABSTRACT

Systems and methods for processing jobs in a Laboratory Management System (LMS) are disclosed. In some embodiments, a method may include identifying, by a user operating an LMS interface provided via one or more computer systems, an electronic record related to one of a plurality of manufacturing orders, determining, by the user, that the identified manufacturing order is being temporarily suspended from production, and adding the electronic record to a hot jobs queue in the LMS interface.

### TECHNICAL FIELD

Embodiments disclosed herein are directed, in general, to systems and methods for processing jobs in a Laboratory Management System (LMS).

### BACKGROUND

Typically, a customer needing to wear glasses may have a prescription filled by an ophthalmologist or by another authorized eye care professional. The customer may then visit an optician to choose a frame and to order ophthalmic lenses, where he or she may try several frames and lenses before making a selection. Thereafter, the optician creates an order according to the customer's selection and sends the order to a lens provider.

Lens providers have different manufacturing techniques available for manufacturing lenses corresponding to the customer's prescription. In some cases, a lens provider may identify the most appropriate lens blank and design to fit the customer's ophthalmic prescription, and may then generate certain manufacturing parameters.

These manufacturing parameters may be sent to one or more manufacturing entities or facilities. In some cases, one or more entities involved in the foregoing processes may employ a computer-based Laboratory Management System (LMS) to help manage the various elements involved in manufacturing glasses and fulfilling customers' orders.

### BRIEF DESCRIPTION OF THE DRAWINGS

Reference will now be made to the accompanying drawings:

FIG. 1 illustrates an example of an environment where a Laboratory Management System (LMS) may be used according to some embodiments.

FIG. 2 is a block diagram of an example of LMS architecture according to some embodiments.

FIG. 3 is a block diagram of an example of a computer systems configured to implement an LMS according to some embodiments.

FIGS. 4-11 are examples of screenshots illustrating a Hot Jobs interface of an LMS according to some embodiments.

FIG. 12 is a flowchart of an example of method for adding a Hot Job to an LMS according to some embodiments.

FIG. 13 is a flowchart of an example of a method for removing a Hot Job from an LMS according to some embodiments.

While this specification provides several embodiments and illustrative drawings, a person of ordinary skill in the art will recognize that the present specification is not limited only to the embodiments or drawings described. It should be understood that the drawings and detailed description are not intended to limit the specification to the particular form disclosed, but, on the contrary, the intention is to cover all modifications, equivalents and alternatives falling within the spirit and scope of the claims. As used herein, the word “may” is meant to convey a permissive sense (i.e., meaning “having the potential to”), rather than a mandatory sense (i.e., meaning “must”). Similarly, the words “include,” “including,” and “includes” mean “including, but not limited to.”

### DETAILED DESCRIPTION

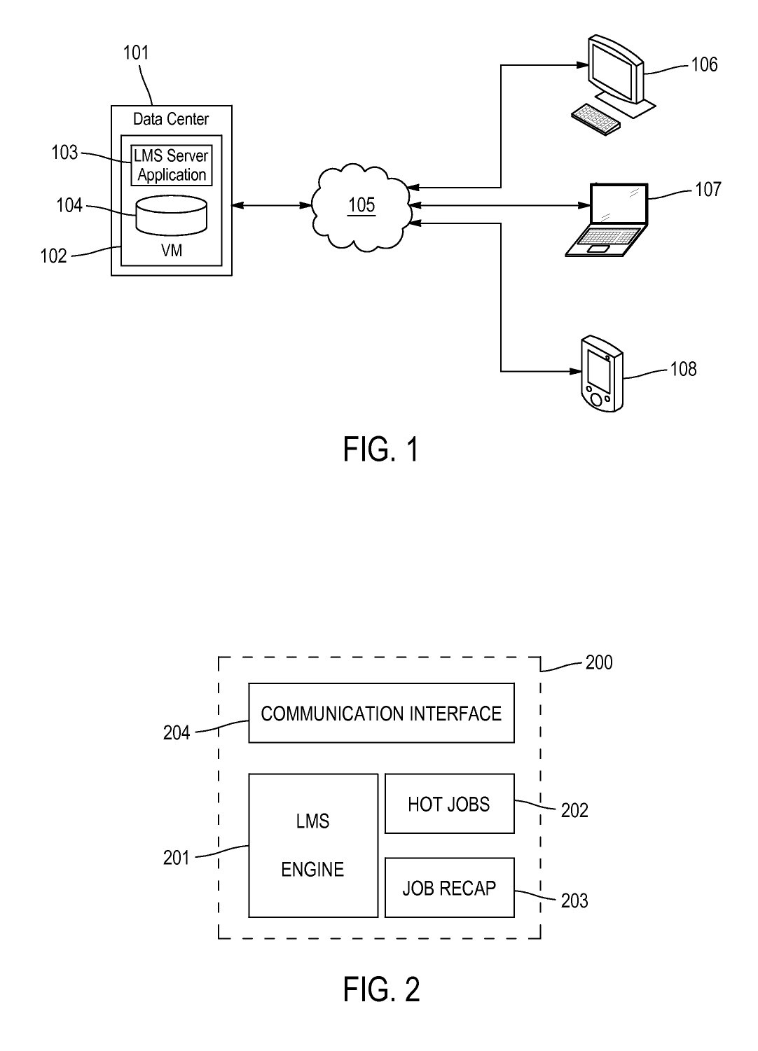

FIG. 1 depicts one environment for providing a Laboratory Management System (LMS). Data center 101 provides a plurality of physical and/or virtual machines (VM) 102 that support an LMS server application 103. In an example embodiment, the LMS server application may be implemented as part of the OPTUITIVE system provided by ESSILOR INTERNATIONAL S.A., with the addition of one or more features described herein. The VMs 102 in data center 101 also provide storage 104, which may hold application data, customer data, order information, etc.

Users, such as doctors, opticians, prescription (RX) processors, and lens manufacturing facilities, access the LMS server application 102 by connecting to data center 101 via network 105 using devices 106-108. Network 105 may be, for example, one or more of the Internet, an intranet, a Local Area Network (LAN), a wireless Local Area Network (WLAN), a wireless data network, etc. Devices 106-108 may include, for example, desktop, notebook, or tablet computers, smartphones, personal digital assistants (PDAs). In one embodiment, the users access the LMS server application 103 using a web browser on devices 106-108. In other embodiments, an LMS client application or Graphical User Interface (GUI) of a native application running on devices 106-108 may be used to access LMS server application 103.

In example cases, an optician may use the LMS application to enter an order for lenses for eyeglasses. The order may comprise information related to a customer's lens prescription and customization information, such as single vision, bifocal, trifocal, progressive, and prism lens selection, lens material (e.g., glass, polycarbonate, plastic, etc.), coating (e.g., antireflective, no glare, UV protection, scratch resistance, anti-static, smudge resistance, water repellence, etc.), tinting, polarization, and/or photochromic options.

LMS server application 102 receives and manages the orders. For example, once received by LMS server application 102, an order request may be sent to a prescription processor to generate manufacturing parameters of an ophthalmic lens. The prescription processor may include processing rules for selecting in a database the most appropriate design for an ophthalmic lens. Additionally or alternatively, processing rules may comprise rules for calculating parameters of an ophthalmic lens so as to obtain the most appropriate design of the lens. These processing rules may represent part of the know-how of the lens provider, and therefore may include sensitive data. Accordingly, in some cases, the prescription processor may be configured to prevent unauthorized access to customer data and processing rules by including suitable encryption and/or other security mechanisms.

Once identified or calculated by the prescription processor, manufacturing parameters may be generated by LMS server application 102 and made available to a manufacturing facility. Manufacturing facility may also provide status information related to one or more lens production jobs to LMS server application 102.

FIG. 2 is a block diagram of an example of an LMS architecture. In some embodiments, LMS architecture 200 may be implemented within LMS server application 103 of FIG. 1. Particularly, LMS architecture 200 may include LMS engine 201, Hot Jobs module 202, modules for other LMS features, such as job recap module 203, and communication interface 204. LMS engine 201 may be configure to control the general operation of LMS server application 103 including, but not limited to, providing a GUI; receiving, storing, and processing of orders requests; receiving, storing, and processing of manufacturing parameters; receiving, storing, and processing of manufacturing status and updates for each job, etc.

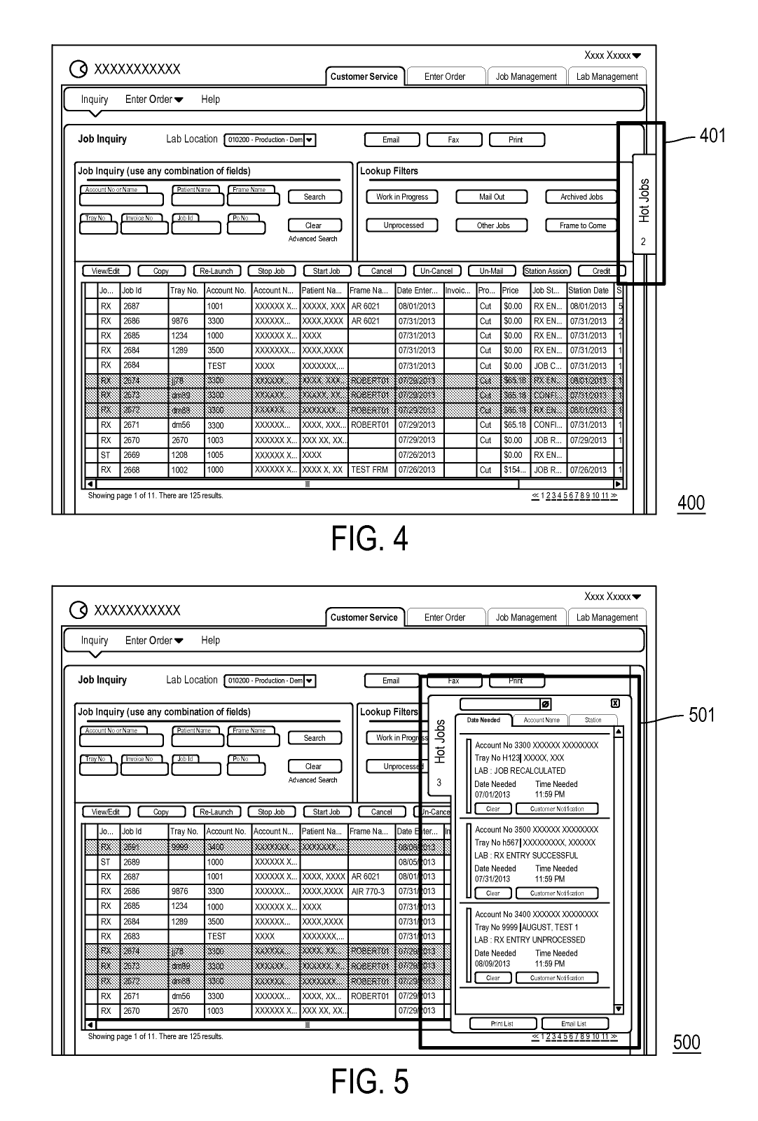

Hot Jobs module 202 may be configured to implement operations described in connection with FIGS. 4-13, for example. Communication interface 204 may be configured to enable communications among LMS server application 103 and user terminals 106-108 over network 105 using any suitable communication protocol.

In various embodiments, modules 200-204 shown in FIG. 2 may represent sets of software routines, logic functions, and/or data structures that are configured to perform operations described herein. Although these modules are shown as distinct logical blocks, in other embodiments at least some of the functionality provided by these modules may be combined into fewer blocks. Conversely, one or more of modules 200-204 may be implemented such that it is divided among two or more logical blocks.

Although shown with a particular configuration, in other embodiments these various modules may be rearranged in other ways. Also, in certain embodiments, each of the different components of LMS architecture 200 may be implemented in software, hardware or a suitable combination thereof, in an integrated fashion (e.g., on a single server or computer system) or in a distributed fashion (e.g., via a number of discrete systems configured to communicate with one another via a network).

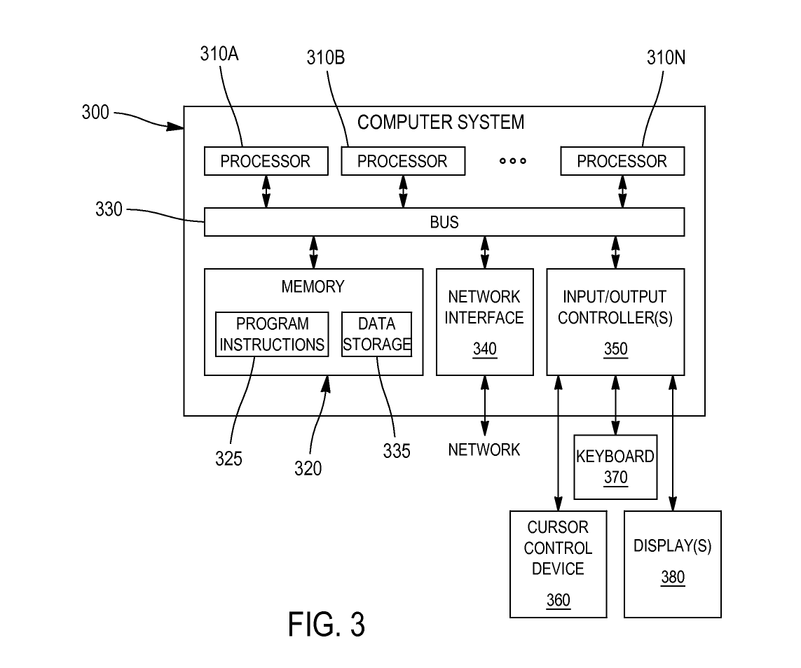

Embodiments of systems and methods for processing jobs in an LMS, as described herein, may be implemented or executed by one or more computer systems. One such computer system is illustrated in FIG. 3. In various embodiments, computer system 300 may be a server, a mainframe computer system, a workstation, a network computer, a desktop computer, a laptop, or the like. For example, in some cases, blocks 200-204 of FIG. 2 may include at least one computer such as computer system 300. Also, each of elements 101, 106-108 of FIG. 1 may include or otherwise be implemented as computer system 300.

As illustrated, computer system 300 includes one or more processor(s) 310A-N coupled to a system memory 320 via bus 330. Computer system 300 further includes a network interface 340 coupled to bus 330, and one or more I/O controllers 330, which in turn are coupled to peripheral devices such as cursor control device 360, keyboard 370, display(s) 380, etc. Each of I/O devices 360-380 may be capable of communicating with I/O controllers 330, for example, via a wired connection (e.g., serial port, Universal Serial Bus port) or wireless connection (e.g., Wi-Fi, Bluetooth, Near Field Communications Link, etc.). Other devices may include, for example, cameras, microphones, antennas/wireless transducers, etc.

In various embodiments, computer system 300 may be a single-processor system including one processor 310A, or a multi-processor system including two or more processors 310A-N (e.g., two, four, eight, or another suitable number). Processor(s) 310A-N may be any processor capable of executing program instructions. For example, in various embodiments, processor(s) 310A-N may be general-purpose or embedded processors implementing any of a variety of instruction set architectures (ISAs), such as the x86, PowerPC®, ARM®, SPARC®, or MIPS® ISAs, or any other suitable ISA. In multi-processor systems, each of processors 310A-N may commonly, but not necessarily, implement the same ISA. Also, in some embodiments, at least one of processor(s) 310A-N may be a graphics processing unit (GPU) or other dedicated graphics-rendering device.

System memory 320 may be configured to store program instructions and/or data accessible by processor 310. In various embodiments, system memory 320 may be implemented using any suitable memory technology, such as static random access memory (SRAM), synchronous dynamic RAM (SDRAM), nonvolatile/Flash-type memory, or any other type of memory. As illustrated, program instructions and data implementing certain operations such as those described herein may be stored within system memory 320 as program instructions 325 and data storage 335, respectively. In other embodiments, program instructions and/or data may be received, sent or stored upon different types of computer-accessible media or on similar media separate from system memory 320 or computer system 300.

Generally speaking, a computer-accessible medium may include any tangible or non-transitory storage media or memory media such as electronic, magnetic, or optical media—e.g., disk or CD/DVD-ROM coupled to computer system 300 via bus 330. The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, bus 330 may be configured to coordinate I/O traffic between processor 310, system memory 320, and any peripheral devices in the device, including network interface 340 or other peripheral interfaces, such as input/output devices 330. In some embodiments, bus 330 may perform any necessary protocol, timing or other data transformations to convert data signals from one component (e.g., system memory 320) into a format suitable for use by another component (e.g., processor(s) 310A-N). In some embodiments, bus 330 may include support for devices attached through various types of peripheral buses, such as a variant of the Peripheral Component Interconnect (PCI) bus standard or the Universal Serial Bus (USB) standard, for example. In some embodiments, the function of bus 330 may be split into two or more separate components, such as a northbridge chipset and a southbridge chipset, for example. In addition, in some embodiments some or all of the functionality of bus 330, such as an interface to system memory 320, may be incorporated directly into processor(s) 310A-N.

Network interface 340 may be configured to allow data to be exchanged between computer system 300 and other devices attached to a network, such as other computer systems, or between nodes of computer system 300. In various embodiments, network interface 340 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

I/O controllers 350 may, in some embodiments, enable communications with one or more display terminals, keyboards, keypads, touchpads, scanning devices, voice or optical recognition devices, mobile devices, or any other devices suitable for entering or retrieving data by one or more computer system 300. Multiple I/O controllers 350 may be present in computer system 300 or may be distributed on various nodes of computer system 300. In some embodiments, I/O devices may be separate from computer system 300 and may interact with one or more nodes of computer system 300 through a wired or wireless connection, such as over network interface 340.

As shown in FIG. 3, memory 320 may include program instructions 325, configured to implement certain embodiments described herein, and data storage 335, comprising various data may be accessible by program instructions 325. In an embodiment, program instructions 325 may include software elements shown in FIG. 2, which may be configured to effect the operations and features discussed below. Program instructions 325 may be implemented in various embodiments using any desired programming language, scripting language, or combination of programming languages and/or scripting languages (e.g., C, C++, C#, Java™, JavaScript™, Perl, etc.). Data storage 335 may include data that may be used in these embodiments (e.g., recorded communications, profiles for different modes of operations, etc.). In other embodiments, other or different software elements and data may be included.

A person of ordinary skill in the art will appreciate that computer system 300 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system configurations.

In various embodiments, the systems and methods of FIGS. 1-3 may be used to implement a “Hot Jobs” feature in an LMS. These features are discussed separately below. It should be noted, however, that in some cases these features may be combined in any suitable manner.

In optical labs, the need arises for customer service representatives (CSRs), lab technicians, supervisors, and other staff to record job information for their future reference. The reasons why lab employees may need to do this can vary. For example, jobs may need to be monitored as they continue through the production process so that their completion can be reported to the customer. Lab employees may stop or put jobs on hold due to issues, and once these issues are resolved, then lab employees may need to release the jobs and return them to production. CSRs or lab technicians may be in the middle of a task, when they are asked to reference or take action on another job; instead of stopping their current task, they may need to write down the job information so that they can return to it when they have completed their current task.

The tracking or notation of jobs such as, for example, those referenced above has traditionally been performed outside of the lab's LMS in an ad hoc basis. Further, the notation and tracking of such jobs largely depends on an individual employee. If the individual is not present in the lab, either due to illness, work shifts, or other circumstances, then other lab employees may not know that a job needs to be watched or a customer notified.

Additionally, supervisors may not be aware of situations or customer service needs that require their intervention. If a lab is not utilizing a shared resource to note tasks or issues, then the sharing of this knowledge is incumbent upon the individual lab employee.

To address these and other concerns, Hot Jobs module 202 may serve as a digital bulletin board. Users may add jobs to Hot Jobs that are of significant importance (or “hot”), and that they may need to easily reference once or multiple times in the near future. Users may add job records to Hot Jobs that are currently in production through the LMS' GUI. Once users add job records to Hot Jobs, those records may appear in a separate part of the LMS user interface—e.g., as a “fly-out panel”—where users can then easily open and view any added Hot Jobs. In addition to the Hot Jobs interface, users may also see which job records are in Hot Jobs when they view job inquiry search results. This may be done, for instance, with a specifically and conspicuously colored highlight (e.g., orange or red) or the like.

Job records may appear in Hot Jobs in an abbreviated version with data that is of most use to users. In addition to the records, Hot Jobs may provide additional functionality within its interface: users may filter and sort the records in order to change which jobs they see and in what order, users may print or email a list of all records in Hot Jobs, and for each individual record, users have options to clear the record from Hot Jobs or communicate with the customer about that specific job.

What jobs users see in the Hot Jobs interface and in the job inquiry search results may be configurable with both lab-level and user-level settings. At the lab-level, labs may choose to allow all users to see all jobs that have been added to Hot Jobs in both their Hot Jobs tab and in the job inquiry search results, regardless of which user actually added the job to Hot Jobs. Labs may also choose to make Hot Jobs specific to each user. In the latter configuration, users may only see jobs they have personally added in their Hot Jobs.

For user-level configuration, user accounts may be given access to see more than just their own Hot Jobs in the Hot Jobs tab. This is most useful in labs that have chosen to make Hot Jobs specific to each user. While most users would only be able to see their own Hot Jobs in the Hot Jobs tab, supervisors and management may be granted permission to view Hot Jobs of other users.

FIGS. 4-11 are examples of screenshots illustrating a Hot Jobs interface of an LMS according to some embodiments. Particularly, FIG. 4 shows minimized Hot Jobs tab 401 on a customer service screen 400. To see the Hot Jobs interface, users may click minimized Hot Jobs tab 401. In response to such an action, FIG. 5 shows screen 500 with Hot Jobs fly-out panel 501 open. Panel 501 may remain open while users continue to work on screen 500. Users may then click the Hot Jobs tab or the “X” to close the Hot Jobs interface and minimize fly-out panel 501 back into Hot Jobs tab 401. In some implementations, an additional fly-out panel (not shown) may be used to allow the user to access a “Notes” tab or the like.

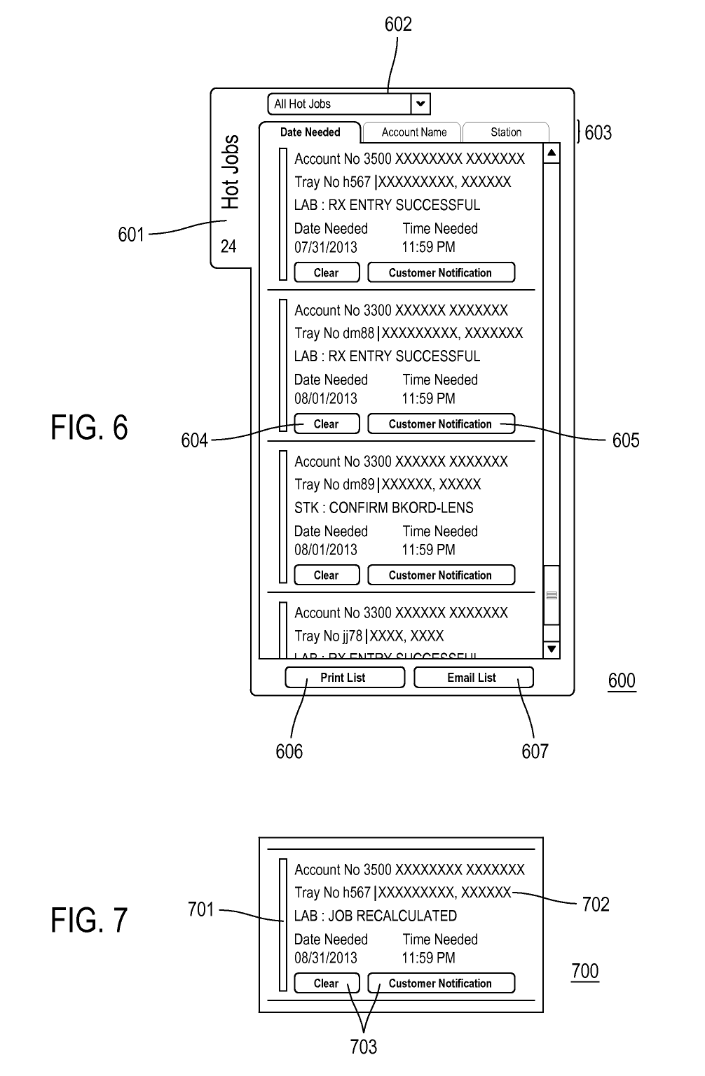

FIG. 6 shows parts of Hot Jobs fly-out panel or interface 600. Hot Jobs tab 601 is configured to allow users to open and close Hot Jobs panel 600. In some cases, it may indicate a number of jobs currently in a Hot Jobs queue. Filter 602 is configured to allow a given to view more than just their own Hot Jobs, for example, when that user has appropriate permissions. Sort tabs 603 are predefined sort options that allow users to view Hot Jobs in order of date needed, account, or job station. Clear button 604 is configured to allow a user to remove the button's respective job record from Hot Jobs. Customer Notification button 605 is configured to allow users to communicate with a customer about a specific Hot Job. Print List button 606 is configured to allow users to print a list of all jobs in Hot Jobs. And Email List button 607 is configured to send by email a list of all the jobs in Hot Jobs.

An example of individual Hot Job record 700 of FIG. 6 is shown in more detail FIG. 7 to illustrate the display key data for a job, intended for at-a-glance viewing by the user. Particularly, in Hot Jobs (and elsewhere in the interface), LMS may color-codes each record according to how close the lab is expected to meet a Date Needed and/or a Time Needed deadline(s). For example, a job coded “green” is on target to meet Date Needed and/or Time Needed deadline(s). A “yellow” job is at risk to not meet the deadline(s)—e.g., time until the job reaches the Date Needed and/or Time Needed deadline is 24 hours or less. Meanwhile, a “red” job is a job that has not met a deadline—e.g., it has gone past the Date Needed and/or Time Needed deadline(s).

Tray number link 702 may be a hyperlink that, when clicked, takes users directly to a corresponding job's order entry screens. Hot Job Tasks 703 include tasks that users may complete for individual Hot Job records including, but not limited to, clearing the record and/or notifying a corresponding customer. The main portion of Hot Job record 700 may include an account number and name (a unique number and name associated with a customer's account), a tray number assigned to a job (where manufactured parts are located), the name of a patient associated with a job, the current status of a job, the date by which an order must or should be completed, and/or a time of day by which the order must or should be completed.

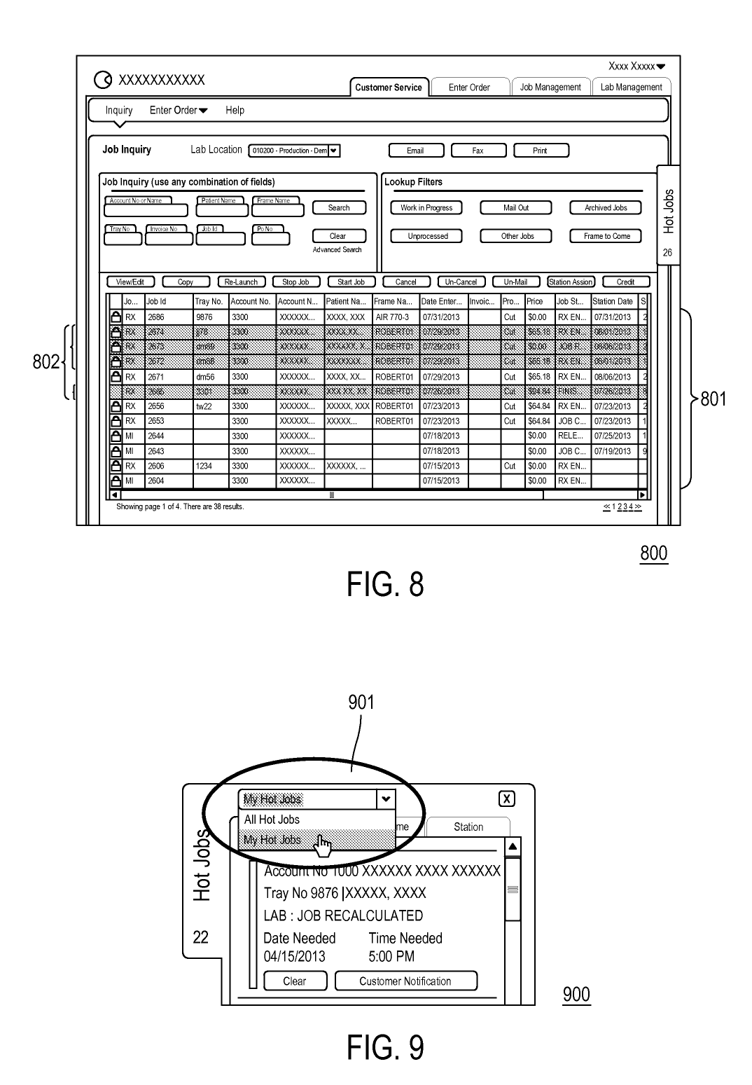

When a user conducts a job inquiry, returned search results 801 may include a highlight for any jobs 802 that are in Hot Jobs, as shown in FIG. 8. In some cases, lab-level and account-level configurations may determine what jobs are highlighted in search results. If a lab is configured to share all Hot Jobs or if the user has permission to view other users' Hot Jobs, then more than just the individual user's personal Hot Jobs may appear highlighted in search results 801.

Referring to FIG. 9, for users who are configured to see other users' Hot Jobs, filter 901 (here in the form of a drop down menu) allows them to choose which Hot Jobs they want to see in Hot Jobs panel 900. Users select from options presented in the Hot Jobs interface. For those users that do not have access, the list is not available.

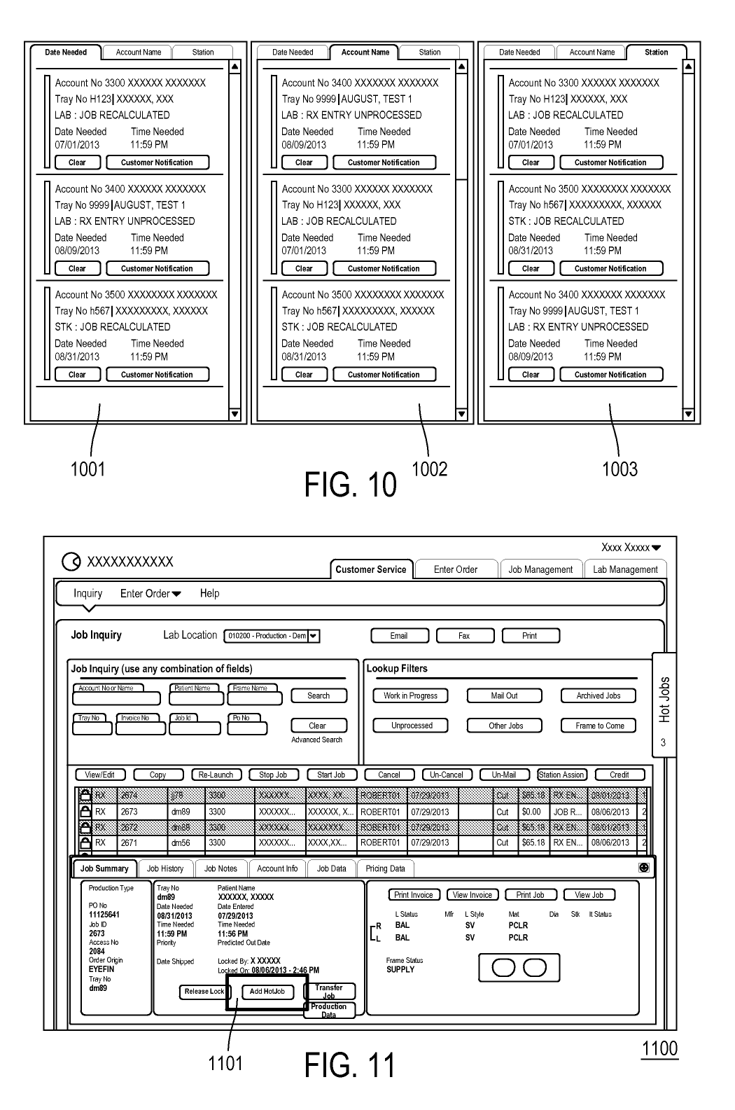

In some embodiments, the Hot Jobs interface provides a number of predefined sort options presented through tabs. In FIG. 10, three such sort options 1001-1003 are shown, and users may click a tab to change the sort order. Particularly, sort option 1001 sorts jobs show in order of the date the job is needed, starting with the earliest to the latest. Sort option 1002 shows jobs grouped according to their associated account, ordered alphabetically by account name. Lastly, sort option 1003 shows jobs grouped by which station (also known as status) they are in, ordered from last station to first station.

As noted above, in various embodiments a Print List control in the Hot Jobs panel may allow users to print a list of the Hot Jobs records currently shown in their Hot Jobs panel. This means that any filter or sort options the user has set will also apply to the printed output. An Email List control in the Hot Jobs panel allows users to send by email a list of the Hot Jobs records currently shown in their Hot Jobs panel, such that any filter or sort options the user has set will also apply to the email output. The Customer Notification control is configured to allow users to communicate by email (or phone call, messaging, etc.) with the customer associated with the job record, which is the account number and name shown on the job record in Hot Jobs. Either configured at the lab-level or user-level, an email or message may be populated with a pre-defined template. Otherwise, the body of the email may be open for users to provide their own specific message for the customer.

FIG. 11 illustrates how to add a job to Hot Jobs. In some implementations, the act of adding a job record to Hot Jobs may be incorporated into parts of the user interface where users work with or view specific jobs. Here, button 1101 named “Add Hot Job” appears in a customer service portion of the LMS, and specifically on fly-out panel 1100 containing a job's data.

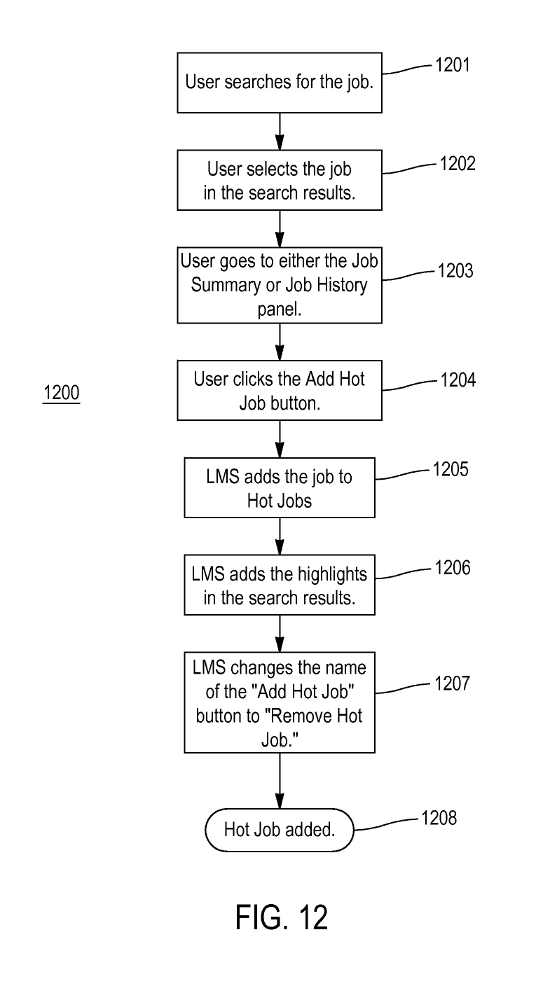

FIG. 12 is a flowchart of an example of method for adding a hot job to an LMS according to some embodiments. Specifically method 1200 begins at block 1201, where a user searches for a given job. At block 1202, the user selects the job in the search results. At block 1203, the user may go either to a job summary or job history panel. At block 1204, the user may click the “Add Hot Job” button or control. At block 1205, the LMS adds the job to Hot Jobs. At block 1206, the LMS adds highlights to the newly added Hot Job in subsequent search results. At block 1207, LMS changes the name of the “Add Hot Job” button to “Remove Hot Job.” Then, at block 1208, the Hot Job is added to a Hot Jobs queue.

Once users no longer need a job record to appear in Hot Jobs, users may access controls to remove the record from Hot Jobs in one of at least two different ways. Users may select the “Clear” button in the Hot Jobs panel, as seen in 6. Additionally or alternatively, users may go to a customer service portion of the LMS—specifically on a fly-out panel with a job's data—to remove the job record.

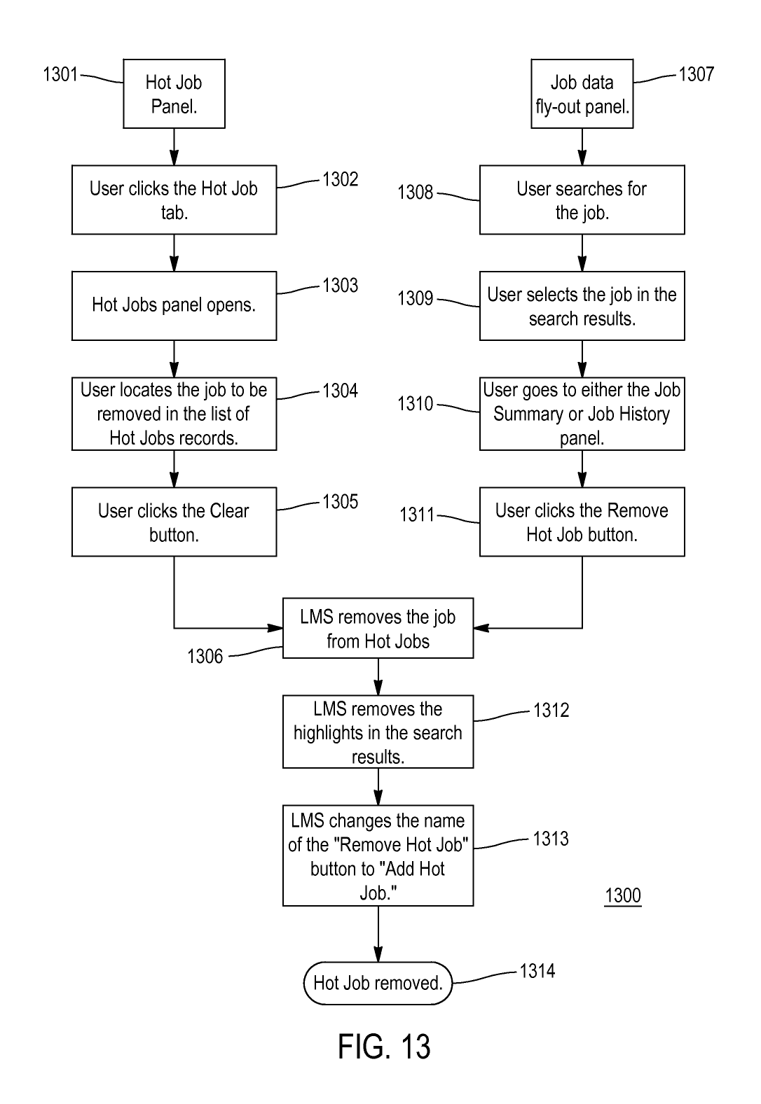

FIG. 13 is a flowchart of an example of a method for removing a Hot Job from an LMS. In some embodiments, method 1300 may start at a Hot Jobs panel 1301 or Job data fly-out panel 1307. When starting from Hot Jobs panel 1301, a user clicks the Hot Jobs tab at block 1302. At block 1303, the Hot Jobs panel opens. At block 1304, the user locates the job to be removed in the list of Hot Job records. At block 1305, the user clicks the “Clear” button. And at block 1306 the LMS removes the job from the Hot Jobs queue.

When starting from Job data fly-out panel 1307, a user searches for a job at block 1308. At block 1309, the user selects the job in the search results. At block 1310, the user goes to either a Job Summary or Job History panel. At block 1311, the user clicks a “Remove Hot Job” button, and control passes to block 1306 where, again, the LMS removes the job from the Hot Jobs queue. At block 1312, LMS removes highlights in the search results for the removed job. At block 1313, LMS changes the name of the “Remove Hot Job” button to “Add Hot Job.” Then, at block 1314, the Hot Job is removed from the Hot Job queue.

It should be understood that the various operations described herein may be implemented in software executed by processing circuitry, hardware, or a combination thereof. The order in which each operation of a given method is performed may be changed, and various operations may be added, reordered, combined, omitted, modified, etc. Furthermore, the various systems and methods illustrated in the figures and described herein represent example embodiments. Modifications and changes may be made as would be understood by a person of ordinary skill in the art having the benefit of this specification. It is intended that the invention(s) described herein embrace all such modifications and changes and, accordingly, the above description should be regarded in an illustrative rather than a restrictive sense.

What is claimed is:

1. A method, comprising:
identifying, by a user operating a Laboratory Management System (LMS) interface provided via one or more computer systems, an electronic record related to one of a plurality of manufacturing orders; and
adding the electronic record to a hot jobs queue in the LMS interface.

2. The method claim 1, wherein the plurality of manufacturing orders include orders for ophthalmic lenses.

3. The method claim 1, wherein the hot jobs queue is displayable via the LMS interface as a list of one or more hot jobs.

4. The method claim 3, wherein the hot jobs queue is displayable via the LMS interface as fly-out panel.

5. The method claim 4, wherein each of the one or more hot jobs includes one or more of:
an account number, a job number, a customer identification, a user identification, a date needed, or a time needed.

6. The method claim 4, wherein each of the one or more hot jobs includes a control configured to allow the user to communicate with a customer associated with a corresponding manufacturing order.

7. The method of claim 3, further comprising sorting or filtering the list of one or more hot jobs via the LMS interface.

8. The method of claim 3, wherein the list of one or more hot jobs excludes manufacturing orders added to the hot jobs queue by other users.

9. The method of claim 1, further comprising performing a job inquiry via the LMS interface and receiving, in response to the job inquiry, a list of manufacturing orders that includes one or more hot jobs.

10. The method of claim 9, wherein the one or more hot jobs are highlighted in the LMS interface.

11. The method of claim 9, wherein each of the one or more hot jobs is color coded to indicate whether the hot job is on target to meet a deadline, whether the hot job is at risk of not meeting a deadline, or whether the hot job is overdue.

12. The method of claim 1, further comprising:
determining, by the user, that the identified manufacturing order is being returned to production; and
removing the electronic record from the hot jobs queue in the LMS interface.

13. A system, comprising:
at least one processor; and
at least one memory coupled to the at least one processor, the at least one memory configured to store program instructions executable by the at least one processor to cause the system to:
receive a user input, via a Laboratory Management System (LMS) interface, identifying an electronic record related to one of a plurality of manufacturing orders; and
adding the electronic record to a hot jobs queue in the LMS interface.

14. The system claim 13, wherein the hot jobs queue is displayable via the LMS interface as a list of one or more hot jobs or as a fly-out panel.

15. The system claim 14, wherein each of the one or more hot jobs includes a control configured to allow the user to communicate with a customer associated with a corresponding manufacturing order.

16. The system of claim 13, wherein the program instructions are further executable by the at least one processor to:
sort or filter the list of one or more hot jobs via the LMS interface.

17. The system of claim 13, wherein the program instructions are further executable by the at least one processor to:
perform a job inquiry via the LMS interface and receive, in response to the job inquiry, a list of manufacturing orders that includes one or more hot jobs.

18. The system of claim 17, wherein each of the one or more hot jobs is color coded to indicate whether the hot job is on target to meet a deadline, whether the hot job is at risk of not meeting a deadline, or whether the hot job is overdue.

19. The system of claim 17, wherein the program instructions are further executable by the at least one processor to
receive an input from the user indicating that the identified manufacturing order is being returned to production; and
remove the electronic record from the hot jobs queue in the LMS interface.

20. A non-transitory computer-readable storage medium having program instructions stored thereon that, upon execution by a computer system, cause the computer system to:
provide a Laboratory Management System (LMS) interface to a user, wherein the LMS interface is configured to allow the user to follow an order input workflow for a prescription job and wherein, to follow the order input workflow, the user's navigates through a plurality of screens of the LMS interface;
receive a user input, via the LMS interface, identifying an electronic record related to one of a plurality of manufacturing orders; and
adding the electronic record to a hot jobs queue in the LMS interface.
